(19) United States
(12) Patent Application Publication
(10) Pub. No.: US 2025/0165749 A1
(43) Pub. Date: May 22, 2025

(54) Method of Predicting Tunnel Boring Machine (TBM) Jamming Based on Deep Neural Network and Numerical Simulation and System Thereof

(71) Applicants: Shijiazhuang Tiedao University, Shijiazhuang, Hebei Province (CN); China State Railway Group Co., Ltd., Beijing (CN)

(72) Inventors: Qian ZHANG, Shijiazhuang, Hebei Province (CN); Yaoqi NIE, Shijiazhuang, Hebei Province (CN); Lijie DU, Shijiazhuang, Hebei Province (CN); Yong ZHAO, Beijing (CN); Siming TIAN, Beijing (CN); Yan MA, Shijiazhuang, Hebei Province (CN); Qingwei LI, Shijiazhuang, Hebei Province (CN); Yalei YANG, Shijiazhuang, Hebei Province (CN)

(21) Appl. No.: 18/747,994

(22) Filed: Jun. 19, 2024

(30) Foreign Application Priority Data
Nov. 21, 2023 (CN) 202311553224.0

(51) Int. Cl. G06N 3/042; G06N 3/0455; G06N 3/0464

(52) U.S. Cl. CPC G06N 3/042; G06N 3/0455; G06N 3/0464

(57) ABSTRACT

A method of predicting tunnel boring machine (TBM) jamming based on deep neural network and numerical simulation and a system thereof are provided, belonging to the technical field of tunnel boring. The method including the following steps: constructing a jamming numerical sample library by using s numerical simulation technology; establishing a jamming prediction model based on the jamming numerical sample library by using a Convolutional Neural Network (CNN) and a Transformer; and implementing real-time monitoring and early warning of TBM jamming by using the jamming prediction model. The present application realizes the real-time monitoring and early warning of TBM jamming, reduces or avoids the jamming phenomenon, and improves the safety and efficiency of TBM construction.

### CROSS-REFERENCE TO RELATED APPLICATION

This patent application claims the benefit and priority of Chinese Patent Application No. 202311553224.0, filed with the China National Intellectual Property Administration on Nov. 21, 2023, the disclosure of which is incorporated by reference herein in its entirety as part of the present disclosure.

### TECHNICAL FIELD

The present disclosure belongs to the technical field of tunnel boring, in particular to a method of predicting tunnel boring machine (TBM) jamming based on deep neural network and numerical simulation and a system thereof.

### BACKGROUND

TBM (tunnel boring machine) is a special construction machinery used in tunnel construction, which has the advantages of high efficiency, safety and environmental protection. However, in the face of complex geological conditions, the TBM is prone to being jammed, that is, the cutter head or the shield of the TBM is squeezed or blocked by a surrounding rock and cannot rotate or advance normally, resulting in serious consequences such as construction delay, equipment damage and safety accidents. Therefore, how to predict the TBM jamming is the main problem now. At present, the technology of predicting the TBM jamming has been developed at home and abroad.
1. The technology based on geological exploration and geological prediction analyzes the bad geological sections that the TBM may encounter by detailed exploration and prediction of geological conditions along the tunnel.
2. The technology based on numerical simulation simulates the tunneling process of the TBM under different geological conditions by establishing a mechanical model of the TBM and the surrounding rock, and analyzes the stress change, deformation features and stability of the surrounding rock, so as to predict the position, type and degree of TBM jamming and provide reference for construction.
3. The technology based on machine learning establishes the prediction model of TBM jamming by collecting the real-time data of the TBM and using the algorithm of machine learning, and realizes real-time monitoring and early warning of jamming.

However, there are still some problems and shortcomings in the existing TBM jamming prediction technology, mainly including the following aspects.
1. Although the technology based on geological exploration and geological prediction can know the geological conditions along the tunnel in advance, it is difficult to cover all geological changes due to the limited precision and scope of geological exploration and geological prediction. Therefore, it is difficult to accurately and timely predict and prevent TBM jamming.
2. Although the technology based on numerical simulation can simulate the interaction between the TBM and the surrounding rock, it is difficult to realize the real-time and dynamic prediction and early warning of TBM jamming because of the complexity and large amount of calculation of numerical simulation in the dynamic boring process.
3. Although the technology based on machine learning can use the real-time data of the TBM for prediction and early warning, it is difficult to realize accurate and stable prediction and early warning of TBM jamming due to the problems of few monitoring samples and imbalance in the application of machine learning in engineering and the limitations of the machine learning algorithm.
4. The same mountain with different geological structures and different boring degrees cannot be predicted.

### SUMMARY

Aiming at the problems and shortcomings of the prior art, the present disclosure provides a method of predicting tunnel boring machine (TBM) jamming based on deep neural network and numerical simulation and a system thereof, aiming at improving the accuracy, real-time performance and stability of TBM jamming prediction and providing more effective technical support for TBM construction.

The technical scheme of the present disclosure is as follows.

A method of predicting tunnel boring machine (TBM) jamming based on deep neural network and numerical simulation is provided, including the following steps:
constructing a jamming numerical sample library by using s numerical simulation technology;
establishing a jamming prediction model based on the jamming numerical sample library by using a Convolutional Neural Network (CNN) and a Transformer; and
implementing real-time monitoring and early warning of TBM jamming by using the jamming prediction model.

Further, constructing a jamming numerical sample library specifically includes:
establishing a mechanical model of the TBM and a surrounding rock, setting reasonable boundary conditions and loading conditions according to mechanical parameters of the TBM and geological parameters of the surrounding rock, and simulating the tunneling process of the TBM under different geological conditions;
setting the range of different jamming influencing factors, and generating different numerical simulation schemes according to a designed orthogonal test scheme.

Further, the mechanical parameter of the TBM includes a cutter head torque, a cutter head rotation speed, a penetration and a cutter head propulsion;
the geological parameter of the surrounding rock includes a compressive strength, an elastic modulus, an elastic wave velocity and a water content.

Further, the jamming influencing factors include a compressive strength, an elastic modulus, an elastic wave velocity, a water content and an integrity coefficient of the rock, and a cutter head torque, a cutter head rotation speed, a penetration and a cutter head propulsion of the TBM.

Further, establishing a jamming prediction model specifically includes:
according to the numerical simulation scheme, operating a numerical simulation model, calculating stress change, deformation features and stability of the surrounding rock under each structure and the jamming degree of the TBM, establishing a jamming risk discrimination index, and calibrating a jamming risk level of each scheme;
storing the jamming influencing factor, the jamming risk discrimination index and the jamming risk level of each scheme as a numerical sample in the jamming numerical sample library as the training data of the Transformer; acquiring B-scan diagrams of different geological structures as training data for training the CNN;
training the Transformer using the jamming numerical sample library, and updating a weight and a bias of the network by a back propagation algorithm, so that an error between an output value of the network and a real value of a sample is minimized to obtain the jamming prediction model.

Further, implementing real-time monitoring and early warning of TBM jamming by using the jamming prediction model specifically includes:
first, exploring and judging the geological structure by geological radar, and inputting the geological structure into the trained CNN model to obtain the jamming weight output by a CNN model; thereafter, collecting the real-time data of the TBM, such as a cutter head torque, a propulsion, a rotation speed, and a slag discharge, and the geological parameters of the surrounding rock, such as a lithology, a water content, and a compressive strength;
taking the jamming weight output by the CNN model, the real-time data of the TBM and the geological parameters of the surrounding rock as input data of the jamming prediction model;
transmitting the input data to the jamming prediction system, and calculating predicted values of the jamming risk discrimination index and the jamming risk level through the jamming prediction model as the output data of the jamming prediction model;
performing real-time monitoring and early warning of TBM jamming according to the output data.

Further, the jamming risk discrimination index is:

$$Newv = \frac{{V}_{t} {σ}_{t}}{{V}_{t + 1} σ t + 1}$$

$$\{ \begin{matrix}Newv \geq 0.3 & jamming \\ 0 \text{.2} \leq Newv < 0 \text{.3} & the risk of jamming is very high \\ 0 \text{.1} \leq Newv < 0.2 & The risk of machine jamming is high \\ Newv < 0 \text{.1} & basically no jamming\end{matrix}$$

Vₜ is the cutter head rotation speed of the TBM at time t, and σₜ is the probability of jamming according to the geological structure in the CNN.

Further, the numerical simulation technology is a finite difference method, and the numerical simulation software is FLAC 3D.

The present disclosure further provides a system of predicting TBM jamming based on deep neural network and numerical simulation, including the following components:
a sensor and monitoring device, which is configured to collect real-time data of the TBM, that is, geological parameters of a surrounding rock;
a jamming prediction model, which is configured to calculate predicted values of a jamming risk discrimination index and a jamming risk level according to the input data as the output data of the jamming prediction model.

The present disclosure has the following technical effects.

By using the numerical simulation technology, the present disclosure constructs a numerical sample library containing different jamming influencing factors and jamming risk levels, which overcomes the problems of lack and unreliability of field data and improves the quality and quantity of data predicted by jamming.

The use of deep neural network in combination with the advantages of the convolutional neural network (CNN) and the Transformer can effectively deal with the time series data, nonlinear relationship and high-dimensional features of TBM jamming prediction, and improve the accuracy and real-time performance of jamming prediction.

Through a cross-validation and grid-searching method, the optimal network structure and parameters are automatically found, which avoids artificial parameter adjustment and selection and improves the stability and reliability of jamming prediction. The real-time monitoring and early warning of TBM jamming are realized. Through a visual interface, the tunneling status, jamming position, type and degree of the TBM, as well as the changing trend of the jamming risk levels are displayed. Through acousto-optic signals, construction workers are reminded of the jamming risk. Through intelligent control, the tunneling parameters of the TBM are adjusted, which reduces or avoids the jamming phenomenon, and improves the safety and efficiency of TBM construction.

### BRIEF DESCRIPTION OF THE DRAWINGS

The accompanying drawings generally illustrate various embodiments by way of example rather than limitation, and together with the description and claims, serve to explain the embodiments of the present disclosure. Where appropriate, the same reference numerals are used throughout the drawings to refer to the same or similar parts. Such embodiments are illustrative and are not intended to be exhaustive or exclusive embodiments of the apparatus or method.

FIG. 1 is a flow chart of cutter head jamming of a training TBM in an embodiment of the present disclosure.

FIG. 2 is a flowchart of using a trained CNN in an embodiment of the present disclosure.

FIG. 3 is a flowchart of using a trained Transformer in an embodiment of the present disclosure.

### DETAILED DESCRIPTION OF THE EMBODIMENTS

It should be noted that the embodiments in the present disclosure and the features in the embodiments can be combined with each other without conflict. The present disclosure will be described in detail with reference to the attached drawings and embodiments.

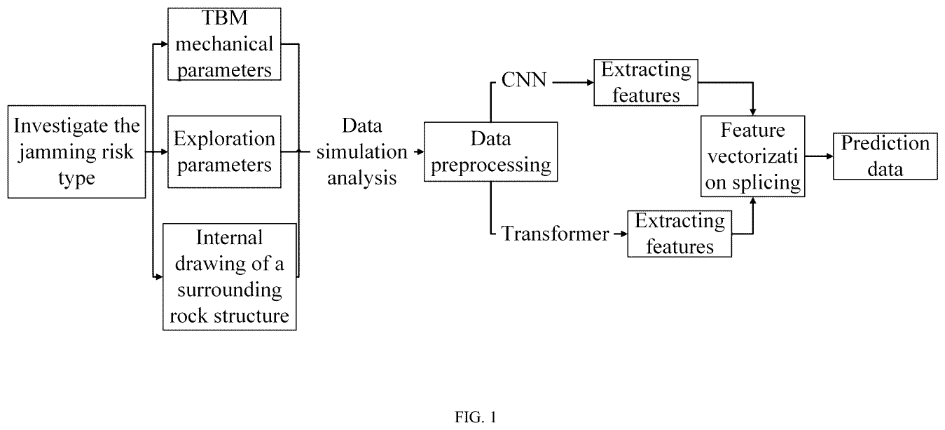

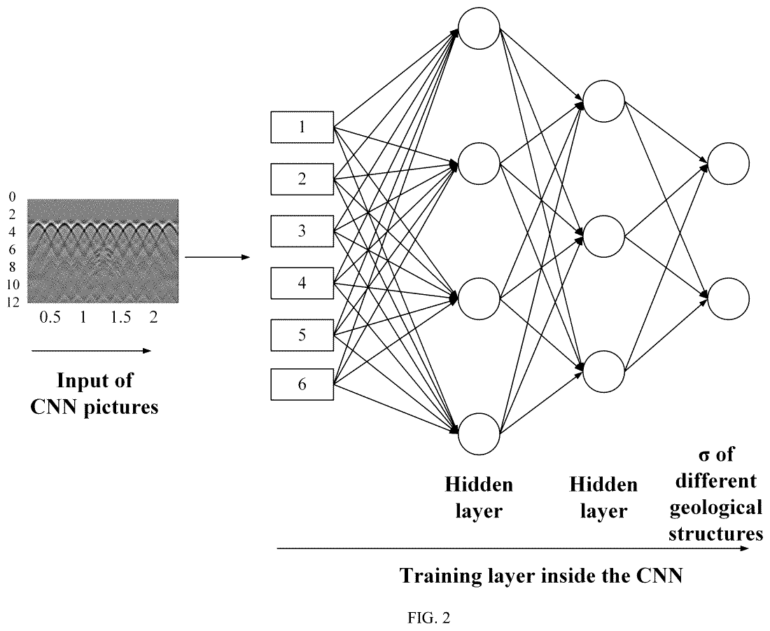

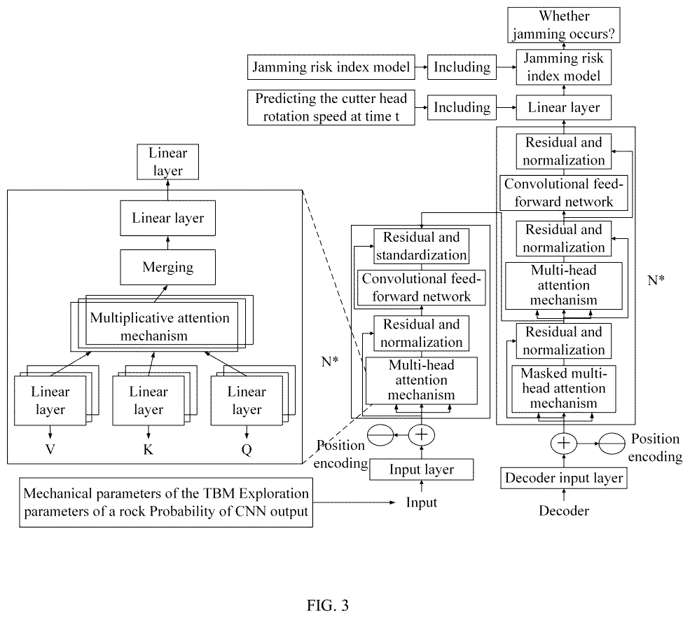

As shown in FIG. 1 to FIG. 3, the specific steps of this embodiment are as follows.

Constructing a jamming numerical sample library by using s numerical simulation technology includes the following sub-steps: setting reasonable boundary conditions and loading conditions according to the structure, parameters and working conditions of the TBM, as well as the geological parameters of the surrounding rock and the construction parameters of the surrounding rock, and simulating the tunneling process of the TBM under different geological conditions. The FLAC 3D software is used for numerical simulation. The range of different jamming influencing factors is set, such as a lithology, a water content and a compressive strength of the surrounding rock, as well as a cutter head torque, a thrust, a rotation speed and a slag discharge of the TBM. Different numerical simulation schemes are generated according to a designed orthogonal test scheme. According to the numerical simulation scheme, a numerical simulation model is operated. Stress change, deformation features and stability of the surrounding rock under each structure, and the jamming degree of the TBM are calculated. A jamming risk discrimination index is established, and the training set is stored for training the deep neural network.

Establishing a jamming prediction model by using the deep neural network includes the following sub-steps: designing the structure of the deep neural network, combining the CNN and the Transformer, which can effectively deal with the time series data, nonlinear relationship and high-dimensional features of TBM jamming prediction. Specifically, the CNN is used to input the geological structure and extract features to obtain the weight of TBM jamming in different geological positions of a single geological structure, and then it is combined with the vectorization of mechanical parameters of the TBM and geological parameters of the surrounding rock to input the Transformer model together. The Transformer is used to capture the dynamic change of the jamming risk identification index, output the rotation speed of the TBM cutter head at time t, and then output the predicted value of the jamming risk level through a fully connected layer according to the discrimination of the jamming model.

Specifically, the parameters of the deep neural network, such as a learning rate, a loss function, an optimizer, etc., and the parameters of the network structure, such as the number of layers, the number of nodes, ab activation function, etc., are selected, or the cross-validation and grid-searching method is used to automatically find the optimal parameters, thus improving the fitting ability and prediction accuracy of the network.

Specifically, the deep neural network is trained by using the jamming numerical sample library, and a weight and a bias of the network are updated by a back propagation algorithm, so that an error between an output value of the network and a real value of a sample is minimized to obtain the jamming prediction model that can accurately predict the jamming risk level.

Specifically, the deep neural network is tested by using the jamming numerical sample database. An error between an output value of the network and a real value of a sample is calculated, so that the prediction performance of the network is evaluated, such as accuracy, recall rate and F1 value, so as to verify the effectiveness and stability of the network.

Implementing real-time monitoring and early warning of TBM jamming by using the jamming prediction model includes the following sub-steps: first, geological radar is used to explore and judge the geological structure, and then a corresponding sensor and monitoring device is installed at the TBM construction site to collect real-time data of the TBM, such as a cutter head torque, a propulsion, a rotation speed, and a slag discharge, and the geological parameters of the surrounding rock, such as a lithology, a water content, a compressive strength, etc., as input data of the jamming prediction model. The input data is transmitted to the jamming prediction system. According to the ratio of the predicted value at time t to Newv at time t+1, it is judged whether jamming occurs. The prediction of the jamming risk discrimination index and the jamming risk level is calculated. Real-time monitoring and early warning of TBM jamming is performed according to the output data. Through a visual interface, the tunneling status, jamming position, type and degree of the TBM, as well as the changing trend of the jamming risk levels are displayed. Through acousto-optic signals, construction workers are reminded of the jamming risk. Through intelligent control, the tunneling parameters of the TBM are adjusted, which reduces or avoids the jamming phenomenon.

Specifically, the resistivity parameters of the surrounding rock are obtained by an excitation and activation method. The water content of the mountain is measured by a resistivity method. The longitudinal wave velocity of a rock mass is obtained by the TST. The rock core is obtained by drilling the rock core in advance. The longitudinal wave velocity of the rock core is obtained, and then the integrity coefficient of the rock is calculated. The compressive strength is calculated by a uniaxial compression test of the rock at different stages, and the elastic modulus of the rock is measured by a triaxial compression test.

The above is only the preferred embodiment of the present disclosure, but the protection scope of the present disclosure is not limited thereto. Any equivalent substitutions or changes made by those skilled in the art according to the technical scheme and inventive concept of the present disclosure within the technical scope disclosed by the present disclosure should be included in the protection scope of the present disclosure.

What is claimed is:

1. A method of predicting tunnel boring machine (TBM) jamming based on deep neural network and numerical simulation, comprising the following steps:
constructing a jamming numerical sample library by using s numerical simulation technology;
establishing a jamming prediction model based on the jamming numerical sample library by using a Convolutional Neural Network (CNN) and a Transformer; and
implementing real-time monitoring and early warning of TBM jamming by using the jamming prediction model.

2. The method of predicting TBM jamming based on deep neural network and numerical simulation according to claim 1, wherein constructing a jamming numerical sample library specifically comprises:
establishing a mechanical model of the TBM and a surrounding rock, setting reasonable boundary conditions and loading conditions according to mechanical parameters of the TBM and geological parameters of the surrounding rock, and simulating the tunneling process of the TBM under different geological conditions;
setting the range of different jamming influencing factors, and generating different numerical simulation schemes according to a designed orthogonal test scheme.

3. The method of predicting TBM jamming based on deep neural network and numerical simulation according to claim 2, wherein
the mechanical parameter of the TBM comprises a cutter head torque, a cutter head rotation speed, a penetration and a cutter head propulsion;
the geological parameter of the surrounding rock comprises a compressive strength, an elastic modulus, an elastic wave velocity and a water content.

4. The method of predicting TBM jamming based on deep neural network and numerical simulation according to claim 2, wherein
the jamming influencing factors comprise a compressive strength, an elastic modulus, an elastic wave velocity, a water content and an integrity coefficient of the rock, and a cutter head torque, a cutter head rotation speed, a penetration and a cutter head propulsion of the TBM.

5. The method of predicting TBM jamming based on deep neural network and numerical simulation according to claim 1, wherein establishing a jamming prediction model specifically comprises:
according to the numerical simulation scheme, operating a numerical simulation model, calculating stress change, deformation features and stability of the surrounding rock under each structure and the jamming degree of the TBM, establishing a jamming risk discrimination index, and calibrating a jamming risk level of each scheme;
storing the jamming influencing factor, the jamming risk discrimination index and the jamming risk level of each scheme as a numerical sample in the jamming numerical sample library as the training data of the Transformer; acquiring B-scan diagrams of different geological structures as training data for training the CNN;
training the Transformer using the jamming numerical sample library, and updating a weight and a bias of the network by a back propagation algorithm, so that an error between an output value of the network and a real value of a sample is minimized to obtain the jamming prediction model.

6. The method of predicting TBM jamming based on deep neural network and numerical simulation according to claim 1, wherein implementing real-time monitoring and early warning of TBM jamming by using the jamming prediction model specifically comprises:
first, exploring and judging the geological structure by geological radar, and inputting the geological structure into the trained CNN model to obtain the jamming weight output by a CNN model; thereafter, collecting the real-time data of the TBM, such as a cutter head torque, a propulsion, a rotation speed, and a slag discharge, and the geological parameters of the surrounding rock, such as a lithology, a water content, and a compressive strength;
taking the jamming weight output by the CNN model, the real-time data of the TBM and the geological parameters of the surrounding rock as input data of the jamming prediction model;
transmitting the input data to the jamming prediction system, and calculating predicted values of the jamming risk discrimination index and the jamming risk level through the jamming prediction model as the output data of the jamming prediction model;
performing real-time monitoring and early warning of TBM jamming according to the output data.

7. The method of predicting TBM jamming based on deep neural network and numerical simulation according to claim 5, wherein the jamming risk discrimination index is:
$$Newv = \frac{{V}_{t} {σ}_{t}}{{V}_{t + 1} σ t + 1}$$
$$\{ \begin{matrix}Newv \geq 0.3 & jamming \\ 0 \text{.2} \leq Newv < 0 \text{.3} & the risk of jamming is very high \\ 0 \text{.1} \leq Newv < 0.2 & The risk of machine jamming is high \\ Newv < 0 \text{.1} & basically no jamming\end{matrix}$$
Vₜ is the cutter head rotation speed of the TBM at time t, and σₜ is the probability of jamming according to the geological structure in the CNN.

8. The method of predicting TBM jamming based on deep neural network and numerical simulation according to claim 1, wherein the numerical simulation technology is a finite difference method, and the numerical simulation software is FLAC 3D.

9. A system of predicting TBM jamming based on deep neural network and numerical simulation, comprising the following components:
a sensor and monitoring device, which is configured to collect real-time data of the TBM, that is, geological parameters of a surrounding rock;
a jamming prediction model, which is configured to calculate predicted values of a jamming risk discrimination index and a jamming risk level according to the input data as the output data of the jamming prediction model.
